(19) United States
(12) Patent Application Publication
(10) Pub. No.: US 2008/0130680 A1
(43) Pub. Date: Jun. 5, 2008

(54) APPARATUS AND METHOD FOR RECEIVING UPSTREAM DATA PACKET

(75) Inventors: Dong Joon CHOI, Daejeon (KR); O. Hyung KWON, Daejeon (KR); Soo In LEE, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 11/928,792

(22) Filed: Oct. 30, 2007

(30) Foreign Application Priority Data
Dec. 5, 2006 (KR) 10-2006-0122526
Jun. 16, 2007 (KR) 10-2007-0071115

(51) Int. Cl. H04J 3/16

(52) U.S. Cl. 370/468

(57) ABSTRACT

An apparatus for receiving an upstream data packet in a channel bonding mode is provided. The apparatus includes: an upstream demodulator for receiving a data packet transmitted from a cable modem and converting the received packet; an upstream processor for adding packet re-combination information to the data packet received from the upstream demodulator; an upstream segment processor for re-combining the data packet received from the upstream processor in response to the packet re-combination information; and an upstream channel band allocation unit for transmitting information comprising a data allocation band and an allocation interval to the cable modem and providing the packet re-combination information to the upstream processor. Also, a method of receiving an upstream data packet in a channel bonding mode is provided.

### CROSS-REFERENCE TO RELATED APPLICATION

This application claims priority to and the benefit of Korean Patent Application No. 2006-122526, filed Dec. 5, 2006, and No. 2007-71115, filed Jul. 16, 2007, the disclosure of which is incorporated herein by reference in its entirety.

### BACKGROUND

1. Field of the Invention

The present invention relates to an apparatus and method for receiving an upstream data packet in a channel bonding mode.

The present invention is derived from a project entitled “Development of 1 Gbps Digital Cable Transceiver System [2005-S-019-01]” conducted as an IT R&D program for the Ministry of Information and Communication (Republic of Korea) and the Institute for Information and Technology Advancement (Republic of Korea).

2. Discussion of Related Art

Currently, in order to transmit data in a cable network, a Cable Modem Transmission System (CMTS) and a cable modem satisfying a Data Over Cable Service Interface Specification (DOCSIS) such as DOCSIS 1.0, DOCSIS 1.1 and DOCSIS 1.2 are widely used. However, as various services are developed, in which communications and broadcasting are combined, the current specifications cannot meet the rising demand for the services in terms of service provision capacity and efficiency. Particularly, in the specification lower than DOCSIS 2.0, the maximum transfer rate is about 40 Mbps in the case of downstream data transmission and about 30 Mbps in the case of upstream data transmission. Therefore, in order to improve the limited transfer rate, a DOCSIS 3.0 specification enables channel bonding, in which data is transmitted using a plurality of physical layers of the CMTS and the cable modem for both the upstream and the downstream.

When upstream data is transmitted using the DOCSIS specification in a Hybrid Fiber Coaxial Cable (HFC) network, a plurality of cable modems share the same frequency band by dividing it into different time slots. That is, when a cable modem intends to transmit data through the HFC network, the CMTS divides an upstream band in use into time slots and transmits information (MAP) regarding time to be used by the corresponding cable modem to a downstream channel. Then, the cable modem transmits as much data as is required for a time interval determined by the MAP. In the case of upstream transmission in the DOCSIS 3.0 specification, when as much data as the cable modem desires to transmit is transmitted to the CMTS as a request message, the CMTS can allocate bands to a plurality of upstream channels set by the cable modem in the process of initial registration. In order to transmit the desired data through the plurality of upstream channels, the cable modem divides the data stored in the intervals allocated to the corresponding cable modem into segments and transmits the data using the MAP and an Upstream Channel Descriptor (UCD) transmitted from the CMTS. Also, when the cable modem transmits bonding data to the upstream channels, the modem compares start points of the band intervals allocated to each channel to sequentially transmit the data. Meanwhile, the sequence of the reception in the CMTS varies depending on endpoints of data transmission by each channel rather than start points of data transmission. Accordingly, the CMTS requires a process in which the data transmitted in the format of a segment are arranged in the original sequence to put it back in the format of DOCSIS MAC data.

### SUMMARY OF THE INVENTION

The present invention is directed to an apparatus and method for receiving an upstream data packet in a channel bonding mode.

The present invention is also directed to an apparatus and method for efficiently receiving data transmitted to a Cable Modem Transmission System (CMTS) via a plurality of upstream channels using an upstream channel bonding mode defined by a Data Over Cable Service Interface Specification (DOCSIS) 3.0.

One aspect of the present invention provides an apparatus for receiving an upstream data packet comprising: an upstream demodulator for receiving a data packet transmitted from a cable modem and converting the received packet; an upstream processor for adding packet re-combination information to the data packet received from the upstream demodulator; an upstream segment processor for re-combining the data packet received from the upstream processor in response to the packet re-combination information; and an upstream channel band allocation unit for transmitting information comprising a data allocation band and an allocation interval to the cable modem and providing the packet re-combination information to the upstream processor.

The packet re-combination information may comprise one of a transmission channel, a transmission band and a transmission interval of the data packet transmitted from the cable modem. Also, the packet re-combination information transmitted from the upstream channel band allocation unit to the upstream processor may comprise a segment information element and may further comprise one of an upstream channel identifier, an interval element and allocation start time.

In addition, the segment information element may comprise a band allocation identifier or a segment number. Furthermore, the upstream processor may comprise: an upstream control data processor for producing an Interval Element Information Primitive in response to the packet re-combination information received from the upstream channel band allocation unit and generating segment information and band information; an upstream reception data processor for converting the data packet in a previously determined format received from the upstream demodulator in response to the segment and band information; and an upstream service flow pre-processor for determining a service flow of the converted data.

The upstream control data processor may comprise: a band allocation interval information processor for generating and storing the Interval Element Information Primitive; and a synchronization stream control and segment information output unit for providing the segment and band information in response to the Interval Element Information Primitive upon the request of the upstream reception data processor. Moreover, the upstream reception data processor may output a data packet having information on an internal header and physical layer reception status only when the data packet in a previously determined format received from the upstream demodulator does not exist.

The upstream service flow pre-processor may determine a service flow according to the converted data received from the upstream reception data processor. The Interval Element Information Primitive may comprise one of a service identifier, the length of an interval use code, start of a minislot, a band allocation identifier, and a segment number.

The converted data may comprise one of an upstream channel identifier, first status, a service identifier, an upstream service flow identifier, start of a minislot, a service cluster pointer, a band allocation identifier and a segment number in the internal header. The upstream segment processor may comprise: a first-in/first-out (FIFO) storage unit for preliminarily storing the converted data packet received from the upstream processor; a segment information processor for retrieving the data packet from the FIFO storage unit to arrange the data packet in a sequence transmitted from the cable modem, and transmitting the arranged packet to a segment preliminary storage unit; a segment preliminary storage unit for classifying and storing the data packets received from the segment information processor for each service flow identifier and band allocation identifier; and a segment re-arranging unit for extracting a packet in a previously determined format from the data packets stored in the segment preliminary storage unit to re-arrange the extracted packet.

The segment information processor may generate a band allocation request information element to transmit the generated results to an upstream band allocation unit when the input data packet comprises band allocation request information. The band allocation request information element may comprise one of an upstream channel identifier, a control flag, a service identifier, start of a minislot, an upstream service flow identifier, a service identifier cluster pointer and interval unit information. The data allocation band that is used to transmit data from the upstream channel band allocation unit to the cable modem may be sequentially allocated over time.

Another aspect of the present invention provides a method of receiving an upstream data packet in a channel bonding mode, comprising the steps of: (a) transmitting information including a data allocation band and an allocation interval to a cable modem; (b) receiving and converting the data packet transmitted from the cable modem; (c) adding packet re-combination information including the information of step (a) to the received data packet; and (d) re-combining the received data packet in response to the packet re-combination information.

The packet re-combination information may comprise information on a transmission channel, a transmission band and a transmission interval of the data packet transmitted from the cable modem. Step (c) may further comprise the steps of: forming an Interval Element Information Primitive in response to the packet re-combination information, and generating segment information and band information; converting the received data packet into data in a previously determined format in response to the segment and band information; and determining a service flow of the converted data. Step (d) may further comprise the steps of: (i) preliminarily storing the received data packet in a previously determined format; (ii) retrieving the stored data packet, and arranging the data packet in a sequence transmitted from the cable modem; (iii) classifying and storing the arranged data packet for each service flow and band allocation identifier; and (iv) extracting a data packet in a previously determined format from the classified and stored data packet, and re-arranging the extracted results.

The method may further comprise the steps of generating a band allocation request information element and transmitting the generated results to an upstream band allocation unit when the input data packet comprises band allocation request information. Step (ii) may further comprise the steps of: obtaining a data packet from a FIFO preliminary storage unit; confirming the total segment number of data including the data packet when the obtained data packet comprises a new band allocation identifier, and calculating the segment number of the obtained data packet; storing user data of the obtained data packet in a segment preliminary storage unit; and sequentially obtaining a data packet from the FIFO preliminary storage unit until the segment number of the obtained data packet becomes the same as the total segment number of the data.

The method may further comprise the step of generating the band allocation request information element when the obtained data packet comprises band allocation request information. Step (iv) may further comprise the steps of: retrieving a segment start address from the segment preliminary storage unit; sequentially obtaining data packet information classified into each segment from the segment start address; and re-combining the data packet when all classified data packet information is obtained, extracting data in a previously determined format from the combined data, and adding an upstream service flow identifier to the extracted data.

Also, the method may further comprise the step of setting a first byte of a memory corresponding to the segment to a previously determined format when data information is not stored in the segment preliminary storage unit. In addition, the data allocation band of step (a) may be sequentially allocated over time.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates the configuration of a cable network according to an exemplary embodiment of the present invention;

FIG. 2 is a flowchart schematically illustrating a sequence of transmitting data according to an exemplary embodiment of the present invention;

FIG. 3 illustrates a method of allocating a channel in a Data Over Cable Service Interface Specification (DOCSIS) 3.0 according to an exemplary embodiment of the present invention;

FIG. 4 illustrates a method of transmitting a segment packet in the DOCSIS 3.0 according to an exemplary embodiment of the present invention;

FIG. 5 schematically illustrates the configuration of an upstream data receiver in a channel bonding mode according to an exemplary embodiment of the present invention;

FIG. 6 illustrates a format of a segment information message transmitted from an upstream channel band allocation unit to an upstream processor according to an exemplary embodiment of the present invention;

FIG. 7 illustrates the detailed configuration of an upstream processor according to an exemplary embodiment of the present invention.

FIG. 8 illustrates a format of an Interval Element Information Primitive message according to an exemplary embodiment of the present invention;

FIG. 9 illustrates a format of a MAC frame message according to an exemplary embodiment of the present invention;

FIG. 10 is a flowchart illustrating a detailed structure of an upstream segment processor according to an exemplary embodiment of the present invention;

FIG. 11 is a flowchart illustrating a method of processing data in the upstream segment processor according to an exemplary embodiment of the present invention;

FIG. 12 illustrates a format of a band allocation request information element message according to an exemplary embodiment of the present invention;

FIG. 13 illustrates a method of storing data in a preliminary storage unit of an upstream segment processor according to an exemplary embodiment of the present invention; and

FIG. 14 is a flowchart illustrating a method of extracting a data packet from a segment re-arranging unit according to an exemplary embodiment of the present invention.

### DETAILED DESCRIPTION OF EMBODIMENTS

The present invention will now be described more fully hereinafter with reference to the accompanying drawings, in which exemplary embodiments of the invention are shown. This invention may, however, be embodied in different forms and should not be construed as limited to the exemplary embodiments set forth herein.

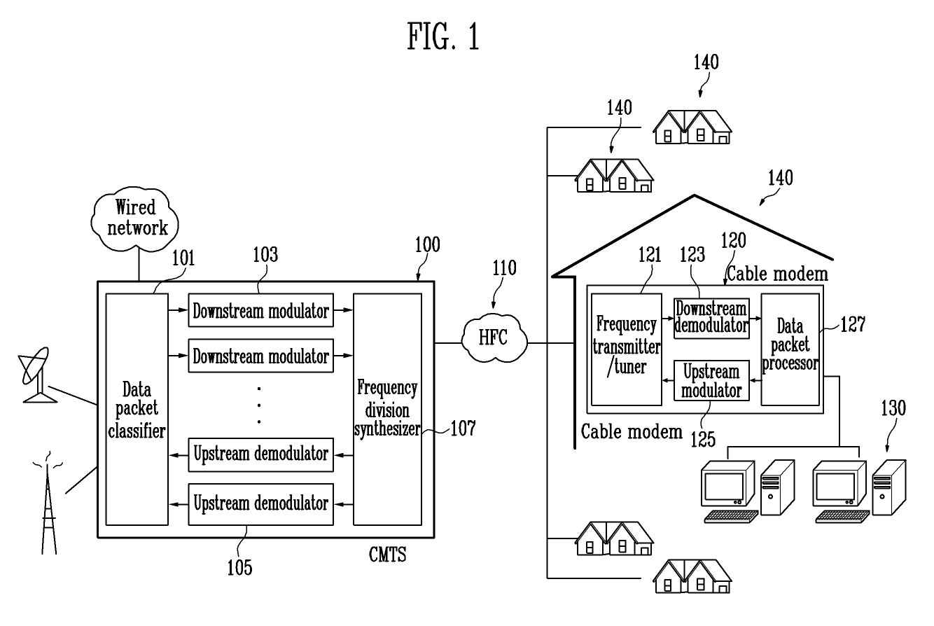

FIG. 1 illustrates the configuration of a cable network according to an exemplary embodiment of the present invention.

Referring to FIG. 1, in the cable network of the present invention, a Cable Modem Transmission System (CMTS) 100 in a head-end of the cable network receives data and transmits the data to a subscriber's place 140 via a Hybrid Fiber Coaxial (HFC) cable. Upstream data generated from the subscriber's place 140 is transmitted to the CMTS 100 in the head-end and then to the external. Here, in the DOCSIS 3.0 channel bonding mode, when a cable modem 120 of the subscriber's place 140 transmits upstream data, a band request signal is transmitted to the CMTS 100. Accordingly, the CMTS 100 allocates an upstream band to the cable modem 120 based on the received signal, and the cable modem 120 transmits the data over the band.

The transmitted data is re-combined in a data packet classifier 101 and transmitted to the external.

That is, the upstream data packet generated from a data receiving terminal 130 is converted into a data packet format by the data packet processor of the cable modem 120. Then, the data is converted into a data packet in a format suitable for a Hybrid Fiber Coaxial (HFC) cable 110 by an upstream modulator 125 and a frequency tuner/transmitter 121 to thereby be transmitted to the CMTS 100. Then, the data packet is received through a frequency division synthesizer 107 of the CMTS 100, and is converted into a packet in a format to be processed by the CMTS 100 in an upstream demodulator 105. Afterward, the data packet classifier 101 re-combines the received data and processes it.

Based on the above processes, the CMTS 100 is coupled with a plurality of cable modems to operate. In the channel bonding mode, since each cable modem does not use the same channel, data packets transmitted from the cable modems are divided into segments to be transmitted, so that the data packets divided into segments should be re-combined in the data packet classifier 101.

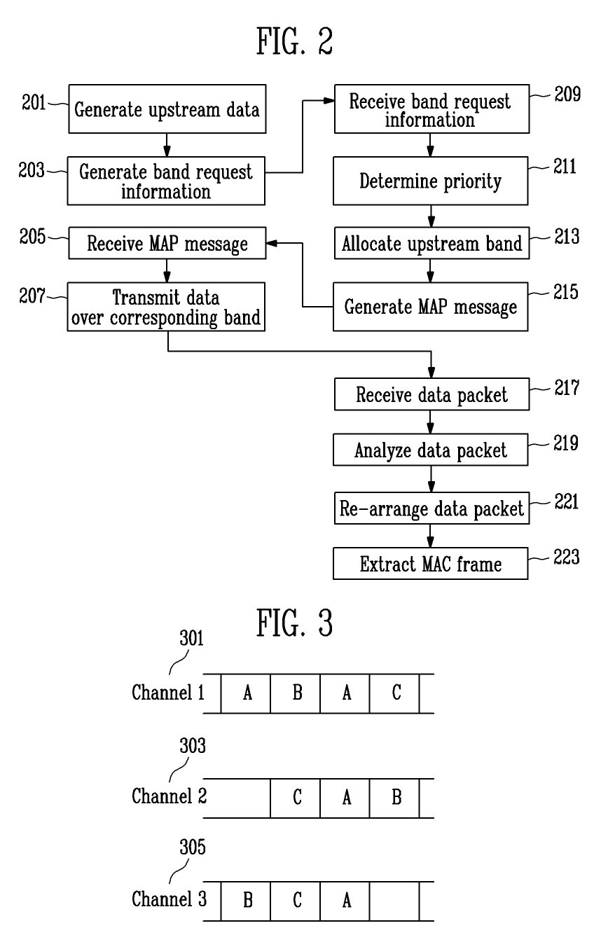

FIG. 2 is a flowchart schematically illustrating a sequence of transmitting data according to an exemplary embodiment of the present invention.

Referring to FIG. 2, upstream data is generated by a cable modem (step 201). Then, the cable modem generates band request information to be transmitted to a CMTS and transmits the information to the CMTS (step 203). The band request information includes a request for information on a band and an interval, both of which are used to transmit data to the CMTS by the cable modem.

The CMTS that receives the band request information (step 209) reviews the band request information to determine a priority according to the upstream data of each cable modem (step 211). Then, the CMTS allocates an upstream band based on the determined priority (step 213), and prepares a MAP message to transmit it to the cable modem (step 215).

The cable modem that receives the MAP message from the CMTS (step 205) transmits data in the corresponding interval of the corresponding band based on the upstream information included in the MAP message (step 207). Then, the CMTS that receives the data packets transmitted from the cable modem (step 217) analyzes the received data packets (step 219) to sequentially re-arrange the received data packets in a sequence transmitted from the cable modem (step 221). Afterwards, a MAC frame is extracted from the re-arranged data packets (step 223).

Since the data packets transmitted from the cable modem have different channels and bandwidths and are transmitted in different intervals, the sequences of the data packets that reach the CMTS are not coincident with those of the transmitted data packets, so that CMTS re-arranges the data packets received from the cable modem.

FIG. 3 illustrates a method of allocating a channel based on the DOCSIS 3.0 specification according to an exemplary embodiment of the present invention.

Referring to FIG. 3, bands allocated to different cable modems are respectively represented as A, B and C, and channels 301, 303 and 305 may be channels that use different modulation methods and have different channel coding methods and minislot lengths.

In a data upstream method of the present invention, data may be transmitted in different modes using different channels. In other words, upstream data that a cable modem A transmits may be simultaneously transmitted through two channels represented as interval A in channel 1, and each one channel represented as interval A in channels 2 and 3, respectively.

When the data is transmitted as described above, the data may be transmitted using different frequencies, unlike the conventional art, so that a very fast transfer rate may be realized.

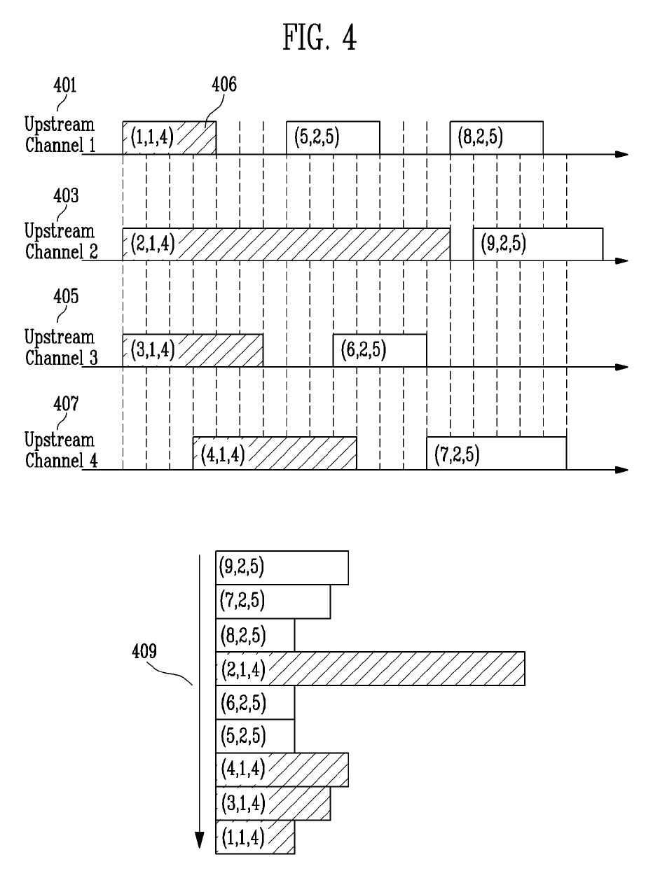

FIG. 4 illustrates a method of transmitting a segment packet in the DOCSIS 3.0 specification according to an exemplary embodiment of the present invention.

Referring to FIG. 4, it can be seen that a CMTS that receives band request information from a cable modem allocates bands with regard to a plurality of channels and a plurality of intervals.

Here, the band request information received from the cable modem is the number of bytes of data to be transmitted based on the queue-depth rather than an amount of minislots in the conventional DOCSIS 2.0 specification.

In this case, the CMTS transmits upstream channel descriptor (UCD) information and MAP information on upstream channels so that data transmitted upstream from the cable modem is transmitted to the plurality of channels, to which bands are allocated. The cable modem divides the upstream data into segments equal to the number that the CMTS designates using the information, and transmits the data over each allocated band.

Reference numerals 406 indicated in the data transmitted via each channel in FIG. 4 sequentially represent, a band allocation identifier, the total segment number of allocated bands, and a priority of band intervals, in which cable modems transmit data.

For example, in the case of (1,1,4), a segment first transmitted to a band allocation interval by the cable modem is represented by 1, a band, to which the segment is allocated is represented by 1 and the total number of band intervals allocated in this band is represented by 4.

In FIG. 4, bands are divided into two bands, i.e., first and second bands, the first band has 4 segments and the second band has 5 segments. In this case, the cable modem sequentially transmits the segments over time as shown in reference numeral 409. However, since the CMTS receives each segment from different channels 401, 403, 405 and 407 regardless of transmitted sequences, it has to rearrange the segments.

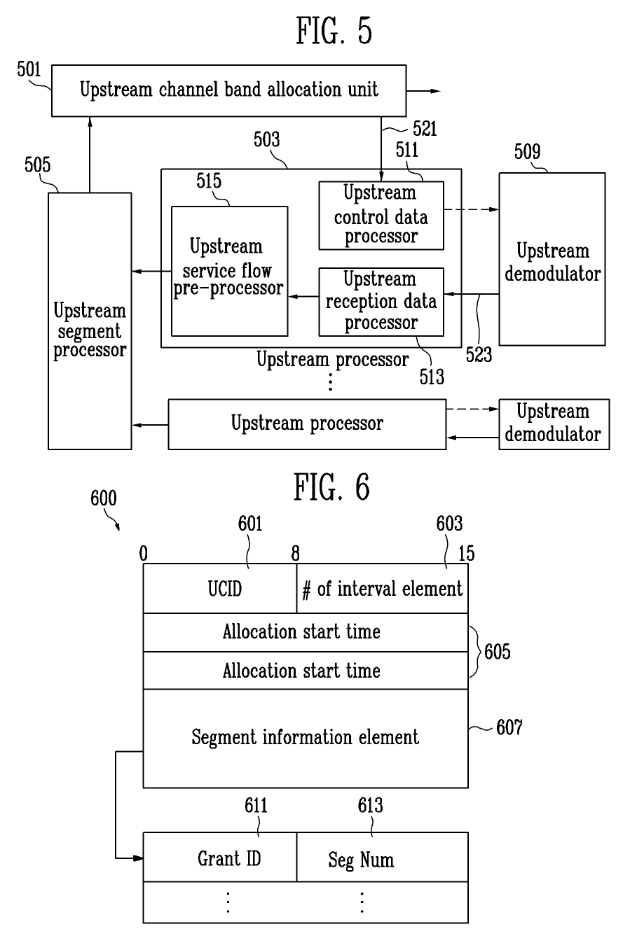

FIG. 5 schematically illustrates the configuration of an upstream data receiver in a channel bonding mode according to an exemplary embodiment of the present invention.

Referring to FIG. 5, the upstream data receiver includes an upstream channel band allocation unit 501, an upstream processor 503, an upstream segment processor 505 and an upstream demodulator 509.

The upstream channel band allocation unit 501 receives band request information input from a cable modem, allocates an upstream channel and a time interval that the corresponding cable modem can transmit, and transmits the information in the format of a MAP message to the cable modem.

Also, it functions to transmit the necessary band allocation information and segment information to the upstream processor to analyze and re-combine the upstream data that the cable modem will transmit based on the above information.

In particular, when the upstream channel band allocation unit 501 allocates a band to the cable modem to efficiently re-combine the upstream data, it sets a start point of every band interval that is currently allocated not to be faster than a start point of every band interval that is previously allocated. Further, the number of bands to be allocated at a time should be set not to exceed the total number of band allocation intervals, which is previously set. Accordingly, the bands allocated by the upstream channel band allocation unit 501 are sequentially allocated over time.

The upstream processor 503 functions to receive data packets from the upstream demodulator 509, additionally input necessary information to an input packet to sequentially re-combine the segment data received from each channel and output the combined data.

The upstream processor 503 includes an upstream control data processor 511, an upstream reception data processor 513 and an upstream service flow pre-processor 515.

The upstream control data processor 511 receives an information message 521 regarding band allocation from the upstream channel band allocation unit 501, converts the received message to comply with a DOCSIS MAC-PHY Interface (DMPI) specification to be output and outputs information corresponding to an input segment data packet to the upstream reception data processor 513.

The upstream reception data processor 513 adds information related to a MAC frame and reception to received data 523 according to the DMPI specification input from the upstream demodulator 509 and transmits the data to the upstream service flow pre-processor 515.

The upstream service flow pre-processor 515 determines a service flow corresponding to the received data and adds the information to the data to be transmitted to the upstream segment processor 505.

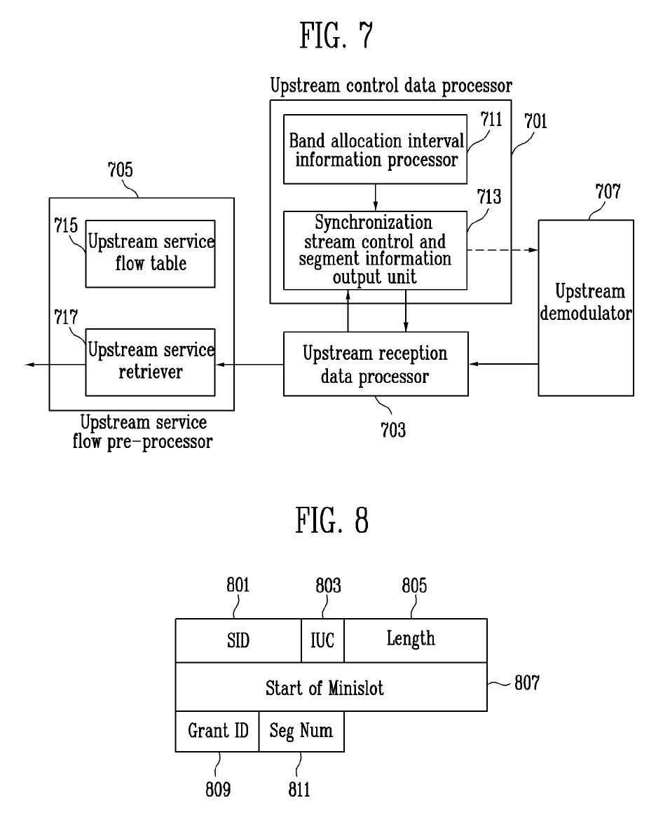

Detailed descriptions of the upstream processor 503 will be made with reference to FIG. 7.

The upstream segment processor 505 functions to analyze segment data that exists in each channel and is transmitted from the upstream processor 503, re-combine the data in a sequence transmitted from the cable modem based on various information added by the upstream processor and convert the data received in a segment format into data into a MAC frame format to be transmitted to a MAC packet delivering unit.

Also, the upstream segment processor 505 functions to extract the band allocation request information included in a header of the segment data to transmit the data to the upstream channel band allocation unit 501.

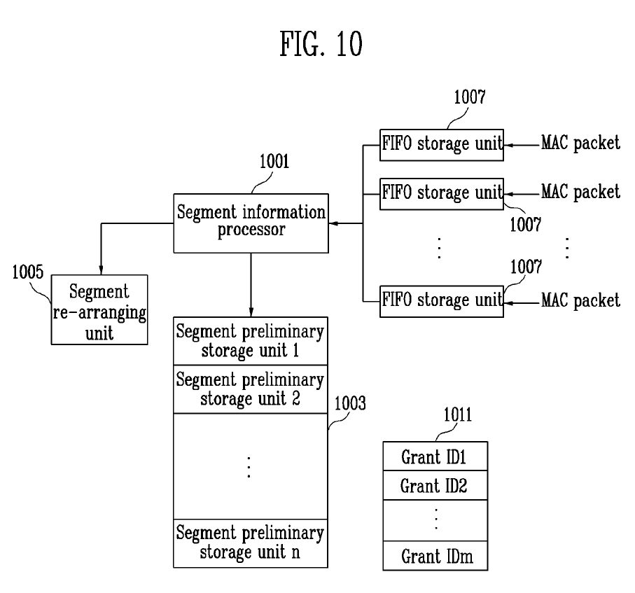

Detailed descriptions of the upstream segment processor 505 will be made with reference to FIG. 10.

FIG. 6 illustrates a format of a segment information message transmitted from an upstream channel band allocation unit to the upstream processor according to an exemplary embodiment of the present invention.

Referring to FIG. 6, the segment information message 600 includes an Upstream Channel ID (UCID) 601, an interval element 603, allocation start time 605 and segment information elements 607.

The UCID 601 consists of 8 bits and represents an identifier of an upstream channel, in which a segment data packet received from a cable modem is included.

The interval element 603 consists of 8 bits and represents a sequence of an interval, in which the data packet is included, in the corresponding channel.

The allocation start time 605 represents a time when the cable modem starts outputting and consists of 32 bits. The allocation start time is synchronized with the allocation start time included in a MAP message, which is transmitted from the upstream channel band allocation unit to the cable modem.

The segment information elements 607 include information on the received segment data, a band grant ID (Grant ID) 611 and a segment number (Seg Num) 613.

The band grant ID 611 is an ID of a band, in which the segment data transmitted from the cable modem is included, and the segment number 613 represents the total segment number included in a band.

FIG. 7 illustrates the detailed configuration of an upstream processor according to an exemplary embodiment of the present invention.

Referring to FIG. 7, the upstream processor includes an upstream control data processor 701, an upstream reception data processor 703 and an upstream service flow pre-processor 705.

The upstream control data processor 701 includes a band allocation interval information processor 711 and a synchronization stream control and segment information output unit 713. The upstream service flow pre-processor 705 includes an upstream service flow table 715 and an upstream service retriever 717.

The band allocation interval information processor 711 functions to receive the segment information message from the upstream channel allocation unit of FIG. 6, process the message for each band allocation interval, and store the processed message in a first-in/first-out (FIFO) storage unit. Here, the message stored in the FIFO storage unit is stored in the format of an Interval Element Information Primitive. Detailed descriptions of the Interval Element Information Primitive format will be made with reference to FIG. 8.

The synchronization stream control and segment information output unit 713 obtains one Interval Element Information Primitive from the FIFO storage unit according to a signal defined in the DOCSIS MAC-PHY Interface of the DOCSIS 3.0 specification and converts it into an upstream control message format to thereby output the converted results. Here, the output message format is in the same format as the message suggested in the DOCSIS 3.0 specification, and thus detailed descriptions thereof will be omitted.

After the Interval Element Information Primitive is stored in a separate memory, when a segment information request signal of the corresponding interval is input from the upstream receiving data processor 703, the band grant ID and the segment number, both of which are included in the Interval Element Information Primitive, are output in response to the input signal.

The upstream reception data processor 703 serves to convert the reception data input from an upstream demodulator 707 into a MAC frame format to be processed in the CMTS and transmit the converted results to the upstream service flow pre-processor 705.

Here, the MAC frame converted in the upstream reception data processor 703 includes all information except for an Upstream_Service Flow ID (US_SFID). The information on the segments of the received data is set by requesting to the synchronization stream control and segment information output unit 713.

In addition, when the upstream demodulator 707 does not receive user data, a packet including an inner header and physical layer reception status only may be output.

The upstream service flow pre-processor 705 analyzes the input MAC frame, determines a service flow corresponding to the MAC frame, and sets the US_SFID of the input data packet.

For this purpose, the upstream service flow pre-processor 705 includes the upstream service retriever 717 for retrieving the US_SFID using the UCID and the SID and the upstream service flow table 715 for retrieving.

FIG. 8 illustrates a message format of the Interval Element Information Primitive according to an exemplary embodiment of the present invention.

Referring to FIG. 8, the Interval Element Information Primitive according to the present invention includes a Service ID (SID) 801, an Interval Usage Code (IUC) 803, a length 805, start of a minislot 807, a band grant ID (Grant ID) 809 and a segment number (SegNum) 811.

The SID 801 is identifier information allocated to each service. The IUC 803 is an identifier identifying a specific burst profile that can be used in a down link or up link transmission interval. The length 805 represents the length of a transmitted data packet, and the start of a minislot 807 represents a point when data in a minislot format starts to be transmitted.

The band grant ID 809 represents a band allocation identifier of an interval, during which data is transmitted, and the segment number 811 represents the total number of transmitted segment data intervals.

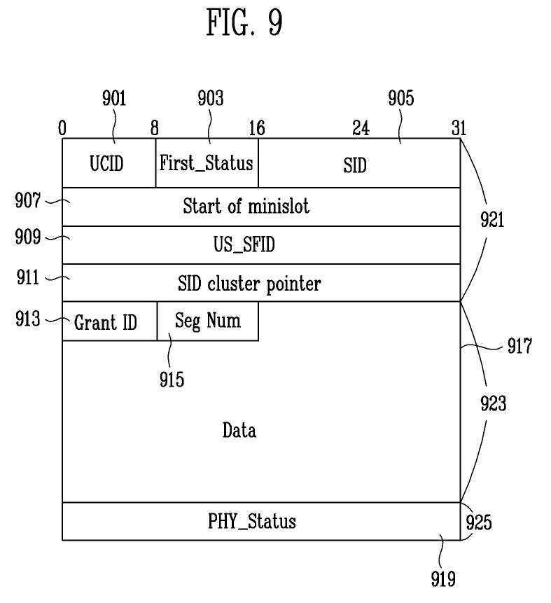

FIG. 9 illustrates a message format of a MAC frame according to an exemplary embodiment of the present invention.

Referring to FIG. 9, the MAC frame represents a data format that is defined to be processed in the CMTS.

The MAC frame includes an Upstream Channel ID (UCID) 901, first status 903, a Service ID (SID) 905, an upstream service flow identifier (US_SFID) 909, start of a minislot 907, a SID Cluster Pointer (SC Pointer) 911, a band grant ID (Grant ID) 913 and a segment number (SegNum) 915 in an inner header 921, and further includes a DOCSIS MAC packet interval 923 including actual data 917 and an internal tail interval 925 indicating a physical status (PHY-status) 919.

The UCID 901 of the inner header 921 represents an identifier of an upstream channel of the received packet, the first status 903 consists of 8 bits, in which the first three bits represent an Interval Usage Code (IUC), the next two bits are stored for the future use, and the last two bits respectively represent a MAC packet only when they indicate “00”, physical status only when they indicate “01” and both the MAC packet and the physical status when they indicate “11”.

The SID 905 represents a service identifier of the corresponding channel, and the US_SFID 909 represents an upstream service flow identifier of an interval, in which the transmitted data is included.

The start of a minislot 907 represents a start point of a minislot during the corresponding data interval, and the SC Pointer 911 represents an address, in which information on a service identifier cluster of the upstream service flow identifier is included, the band grant ID 913 represents a band allocation identifier of an interval, in which the transmitted data is included, and the segment number 915 represents the total number of intervals of the transmitted segment data.

The DOCSIS MAC packet interval 923 includes data 917 transmitted from the cable modem, and the internal tail interval 925 represents the physical status of a packet.

FIG. 10 illustrates the detailed structure of an upstream segment processor according to an exemplary embodiment of the present invention.

Referring to FIG. 10, a MAC packet transmitted from an upstream processor is stored in a FIFO storage unit 1007, and a segment information processor 1001 reads the MAC packets, which exist in each channel, in a sequence stored in the upstream processor to process segment information. Here, the processed packets are transmitted to segment preliminary storage units 1003, and when the number of the processed packets is equal to the number of segments allocated in a band, a segment re-arranging unit 1005 extracts a DOCSIS MAC frame to transmit the extracted results externally.

The segment preliminary storage units 1003 are divided into sections according to the upstream service flow, and also divided into sections according to each band grant ID in each service flow.

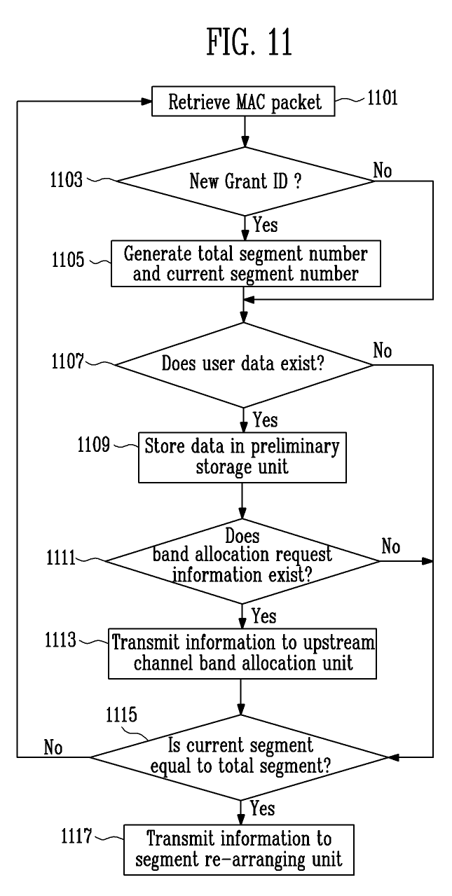

FIG. 11 is a flowchart illustrating a method of processing data in an upstream segment processor according to an exemplary embodiment of the present invention.

Referring to FIG. 11, first, a MAC packet included in a FIFO memory is retrieved (step 1101). Then, the retrieved MAC packet is analyzed to confirm whether the packet includes a new band grant ID (Grand ID) (step 1103). When the packet includes the new band grant ID, the total segment number of an interval, in which the packet is included and the current segment number are generated using information included in the MAC packet (step 1105). The total segment number is set using SegNum information of the MAC packet, and the current segment number is set to 1 when the new band grant ID is input, otherwise one is added to the original segment number each time. Meanwhile, when the new band grant ID is not included, the process immediately moves to step 1107.

Then, whether or not user data exists in the input MAC packet is confirmed (step 1107), and when the user data exists, the data is stored in a preliminary storage unit (step 1109). Afterwards, whether or not band allocation information is included is confirmed (step 1111), and when the information is included, the information is transmitted to an upstream channel band allocation unit so that a band is allocated (step 1113).

Then, whether the total segment number generated in step 1105 is equal to the current segment number is determined (step 1115), and when the current segment number is less than the total segment number, it is returned to step 1101 to perform the above processes. When they are equal to each other, data information is transmitted to a segment re-arranging unit (step 1117).

Meanwhile, when the user data is not included or any band allocation request information is not included in steps 1107 and 1111, it is immediately moved to step 1115 to perform the processes.

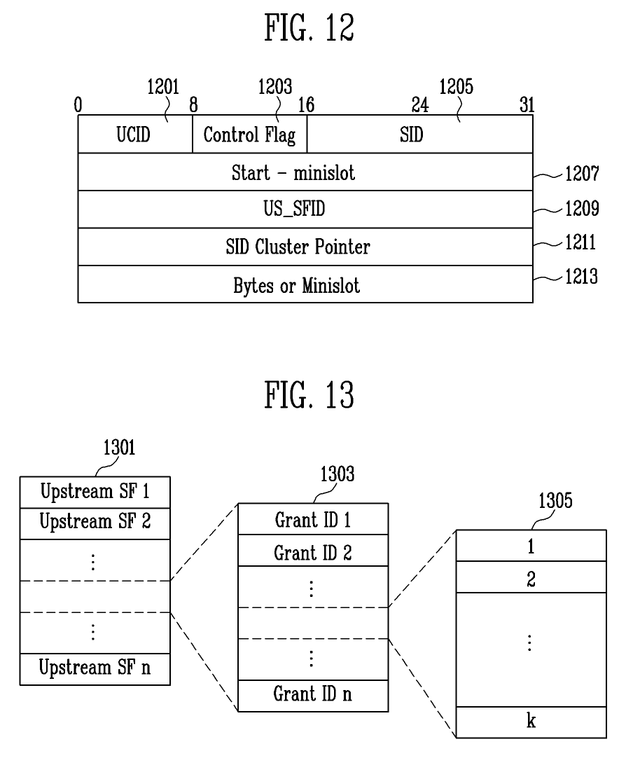

FIG. 12 illustrates a message format of a band request allocation information element according to an exemplary embodiment of the present invention.

Referring to FIG. 12, the band request allocation information element is a message transmitted from an upstream segment processor to an upstream channel band allocation unit. The message enables the upstream channel band allocation unit to generate a MAP message when band allocation request information exists in a data packet received from a cable modem.

The band request allocation information element includes an Upstream Channel ID (UCID) 1201, a control flag 1203, a Service ID (SID) 1205, start of minislot 1207, an upstream service flow ID (US_SFID) 1209, a Service ID Cluster Pointer (SID Cluster Pointer) 1211 and a byte or minislot 1213.

Here, the SID Cluster Pointer 1211 includes an address, in which the service identifier 1205 of the upstream service flow identifier 1209 is included. Further, the byte or minislot 1213 is in a byte unit when a seventh bit of the control flag 1203 is 1 and is in a minislot unit when the bit is 0.

The control flag 1203 consists of 8 bits and its first four bits represent the IUC. Also, the next three bits represent the SID Cluster ID when the seventh bit of the control flag 1203 is “1”, and represent “Don't Care” when the bit is “0”.

The last one bit represents whether a request is in a byte unit or a minislot unit as described above.

FIG. 13 illustrates a method of storing data in a preliminary storage unit of an upstream segment processor according to an exemplary embodiment of the present invention.

Referring to FIG. 13, data is stored in the preliminary storage unit when there exists the user data as illustrated in FIG. 11. This case corresponds to the case when the sixth and seventh bits of the first status are “11” in FIG. 9, i.e., there exists the user data in an input packet.

In this case, when the data is stored in the preliminary storage unit, the data is stored to correspond to serial numbers included in a segment to be easily output. Therefore, each of the input packets is stored in a separate space according to an upstream service flow and a band allocation identifier.

Reference numeral 1301 of FIG. 13 represents the packet that is separately stored according to each upstream service flow. The packet is stored in the separate space according to each service flow and each band allocation identifier (1303). In addition, each segment information is stored in a separate space according to the band allocation identifier (1305). Accordingly, when a service flow starts to confirm a start address of each data, a memory space is initialized and a start pointer representing a packet start point of each allocation identifier is set.

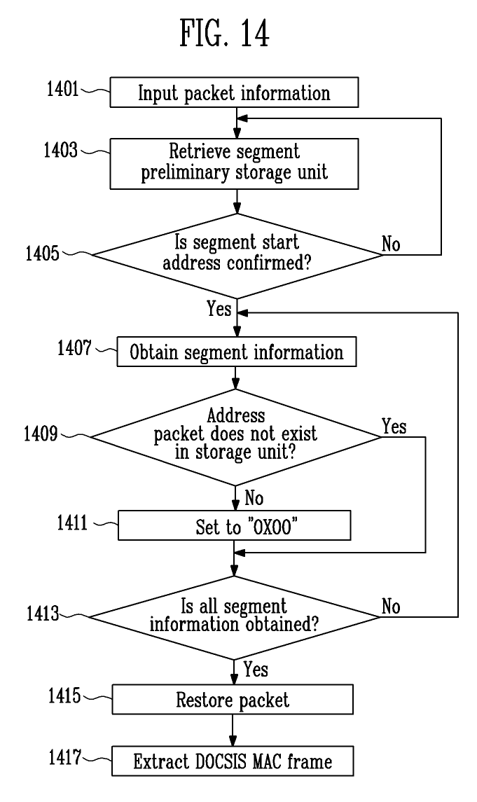

FIG. 14 is a flowchart illustrating a method of extracting a data packet from a segment re-arranging unit according to an exemplary embodiment of the present invention.

Referring to FIG. 14, a band allocation information identifier and upstream service flow information are input (step 1401). Then, a segment preliminary storage unit is retrieved (step 1403) to confirm a start address of a segment (step 1405).

In this case, memory addresses are sequentially retrieved until a segment start address is found. When the segment start address is retrieved, information on the corresponding segment is obtained (step 1407) to confirm whether the data packet exists in the address of the storage unit (step 1409). When the packet does not exist in the address, the retrieved portion is set to “0X00”. Afterwards, whether or not all segment information is obtained is confirmed (step 1413), and when all segment information is not obtained, the method returns to step 1407 to repeat the above processes. Further, when all segment information is obtained, the data packet is restored based on the obtained segment information (step 1415), and a DOCSIS MAC frame is extracted to transmit the extracted results externally (step 1417).

According to the present invention, a method and an apparatus for receiving an upstream data packet in a channel bonding mode may be provided.

Furthermore, according to the present invention, a method and an apparatus for efficiently receiving data transmitted to a Cable Modem Transmission System (CMTS) via a plurality of upstream channels using an upstream channel bonding mode defined by a DOCSIS 3.0 specification may be provided.

While the present invention has been shown and described with reference to certain exemplary embodiments thereof, it will be understood by those skilled in the art that various changes in form and details may be made therein without departing from the spirit and scope of the present invention as defined by the appended claims.

What is claimed is:

1. An apparatus for receiving an upstream data packet, comprising:
an upstream demodulator for receiving a data packet transmitted from a cable modem and converting the received packet;
an upstream processor for adding packet re-combination information to the data packet received from the upstream demodulator;
an upstream segment processor for re-combining the data packet received from the upstream processor in response to the packet re-combination information; and
an upstream channel band allocation unit for transmitting information comprising a data allocation band and an allocation interval to the cable modem and providing the packet re-combination information to the upstream processor.

2. The apparatus of claim 1, wherein the packet re-combination information comprises one of a transmission channel, a transmission band and a transmission interval of the data packet transmitted from the cable modem.

3. The apparatus of claim 1, wherein the packet re-combination information transmitted from the upstream channel band allocation unit to the upstream processor comprises a segment information element and further comprises one of an upstream channel identifier, an interval element and an allocation start time.

4. The apparatus of claim 3, wherein the segment information element comprises a band allocation identifier or a segment number.

5. The apparatus of claim 1, wherein the upstream processor comprises:
an upstream control data processor for producing an Interval Element Information Primitive in response to the packet re-combination information received from the upstream channel band allocation unit and generating segment information and band information;
an upstream reception data processor for converting the data packet in a previously determined format received from the upstream demodulator in response to the segment and band information; and
an upstream service flow pre-processor for determining a service flow of the converted data.

6. The apparatus of claim 5, wherein the upstream control data processor comprises:
a band allocation interval information processor for generating and storing the Interval Element Information Primitive; and
a synchronization stream control and segment information output unit for providing the segment and band information in response to the Interval Element Information Primitive upon the request of the upstream reception data processor.

7. The apparatus of claim 5, wherein the upstream reception data processor outputs a data packet having information on an internal header and physical layer reception status only when the data packet in a previously determined format received from the upstream demodulator does not exist.

8. The apparatus of claim 5, wherein the upstream service flow pre-processor determines a service flow according to the converted data received form the upstream reception data processor.

9. The apparatus of claim 6, wherein the Interval Element Information Primitive comprises one of a service identifier, a length of an interval use code, start of a minislot, a band allocation identifier, and a segment number.

10. The apparatus of claim 5, wherein the converted data comprises one of an upstream channel identifier, a first status, a service identifier, an upstream service flow identifier, start of a minislot, a service cluster pointer, a band allocation identifier and a segment number in the internal header.

11. The apparatus of claim 1, wherein the upstream segment processor comprises:
a first-in/first-out (FIFO) storage unit for preliminarily storing the converted data packet received from the upstream processor;
a segment information processor for retrieving the data packet from the FIFO storage unit to arrange the data packet in a sequence transmitted from the cable modem, and transmitting the arranged packet to a segment preliminary storage unit;
a segment preliminary storage unit for classifying and storing the data packets received from the segment information processor for each service flow identifier and band allocation identifier; and
a segment re-arranging unit for extracting a packet in a previously determined format from the data packets stored in the segment preliminary storage unit to re-arrange the extracted packet.

12. The apparatus of claim 11, wherein the segment information processor generates a band allocation request information element to transmit the generated results to an upstream band allocation unit when the input data packet comprises band allocation request information.

13. The apparatus of claim 12, wherein the band allocation request information element comprises one of an upstream channel identifier, a control flag, a service identifier, start of a minislot, an upstream service flow identifier, a service identifier cluster pointer, and interval unit information.

14. The apparatus of claim 1, wherein the data allocation band that is used to transmit data from the upstream channel band allocation unit to the cable modem is sequentially allocated over time.

15. A method of receiving an upstream data packet in a channel bonding mode, comprising the steps of:
(a) transmitting information including a data allocation band and an allocation interval to a cable modem;
(b) receiving and converting the data packet transmitted from the cable modem;
(c) adding packet re-combination information including the information of step (a) to the received data packet; and
(d) re-combining the received data packet in response to the packet re-combination information.

16. The method of claim 15, wherein the packet re-combination information comprises information on a transmission channel, a transmission band and a transmission interval of the data packet transmitted from the cable modem.

17. The method of claim 15, wherein step (c) further comprises the steps of:
forming an Interval Element Information Primitive in response to the packet re-combination information, and generating segment information and band information;
converting the received data packet into data in a previously determined format in response to the segment and band information; and
determining a service flow of the converted data.

18. The method of claim 15, wherein step (d) further comprises the steps of:
(i) preliminarily storing the received data packet in a previously determined format;
(ii) retrieving the stored data packet, and arranging the data packet in a sequence transmitted from the cable modem;
(iii) classifying and storing the arranged data packet for each service flow and band allocation identifier; and
(iv) extracting a data packet in a previously determined format from the classified and stored data packet, and re-arranging the extracted results.

19. The method of claim 18, further comprising the steps of generating a band allocation request information element, and transmitting the generated results to an upstream band allocation unit when the input data packet comprises band allocation request information.

20. The method of claim 18, wherein step (ii) further comprises the steps of:
obtaining a data packet from a FIFO preliminary storage unit;
confirming the total segment number of data including the data packet when the obtained data packet comprises a new band allocation identifier, and calculating the segment number of the obtained data packet;
storing user data of the obtained data packet in a segment preliminary storage unit; and
sequentially obtaining a data packet from the FIFO preliminary storage unit until the segment number of the obtained data packet becomes the same as the total segment number of the data.

21. The method of claim 20, further comprising the step of generating a band allocation request information element when the obtained data packet comprises band allocation request information.

22. The method of claim 18, wherein step (iv) further comprises the steps of:
retrieving a segment start address from the segment preliminary storage unit;
sequentially obtaining data packet information classified into each segment from the segment start address; and
re-combining the data packet when all classified data packet information is obtained, extracting data in a previously determined format from the combined data, and adding an upstream service flow identifier to the extracted data.

23. The method of claim 22, further comprising the step of setting a first byte of a memory corresponding to the segment to a previously determined format when data information is not stored in the segment preliminary storage unit.

24. The method of claim 15, wherein the data allocation band of step (a) is sequentially allocated over time.
